(19) United States
(12) Patent Application Publication
(10) Pub. No.: US 2018/0299093 A1
(43) Pub. Date: Oct. 18, 2018

(54) LIGHT SOURCE MODULE FOR LIGHTING DEVICE

(71) Applicant: Xuan Fan Electro-optical Technology Co., Ltd., New Taipei City (TW)

(72) Inventors: Po-Heng LAI, New Taipei City (TW); Ming-Teng KUO, New Taipei City (TW); Jian-Lun CHEN, New Taipei City (TW)

(21) Appl. No.: 15/950,526

(22) Filed: Apr. 11, 2018

(30) Foreign Application Priority Data
Apr. 14, 2017 (TW) 106205232

(51) Int. Cl. F21S 45/47; F21S 41/148; F21S 41/19; F21S 45/43; F21S 41/30; F21S 41/20

(52) U.S. Cl. CPC F21S 45/47; F21S 41/148; F21S 41/192; F21Y 2115/10; F21S 41/30; F21S 41/285; F21S 45/43

(57) ABSTRACT

A light source module for an illumination device and the illumination device are provided. The illumination device comprises a stationary base having a first fixing structure. The light source module comprises a seat, at least one light emitting diode and a heat dissipation body. The seat extends along an axis and has a carrying surface. The light emitting diode is disposed on the carrying surface. The heat dissipation body is connected with an end of the seat and has a second fixing structure which is able to assemble with the first fixing structure so that the light source module can be secured on the stationary base of the light source module. Thereby, the length of the seat can be reduced and the heat dissipation efficiency of the heat dissipation body can be increased.

### CROSS REFERENCE TO RELATED APPLICATION

This application claims the benefits of the Taiwan Patent Application Serial Number 106205232, filed on Apr. 14, 2017, the subject matter of which is incorporated herein by reference.

### BACKGROUND OF THE INVENTION

### 1. Field of the Invention

The present invention relates to a light source module for a lighting device and, more particularly, to a light source module for an automotive lighting device.

### 2. Description of Related Art

With the development of integrated circuit design, semiconductor manufacturing process and optoelectronic technology, light emitting diodes (LEDs) have been considered as optimal light sources of next generation lamps. Particularly, LEDs have been widely applied in various lighting fields due to their favorable properties including higher lumen output per watt, improved illumination efficiency and longer lifetime. In the automotive lighting field, more and more LED vehicle headlamps have satisfied the illumination requirements, resulting in the trend of traditional vehicle halogen headlamps and vehicle HIDs being gradually replaced with LEDs.

As the traditional vehicle halogen headlamps have established configurations and specifications, an LED light source module should be configured to be compatible with the existing lamp structure. Please refer to FIGS. 1 and 2, which are exploded perspective and side cross-sectional views, respectively, of a light source module 1 and an automotive lighting device 2 in accordance with prior art. As shown in FIG. 1, the automotive lighting device 2 has a lens 21, a housing 22 and a snapping structure 23. The lens 21 and the snapping structure 23 are disposed at two opposite ends of the housing 22, respectively. The light source module 1 has an LED light source 11, a light source carrier 12, a lamp disk 13 and a heat spreader 14. The heat spreader 14 is connected to one end of the light source carrier 12. The LED light source 11 is disposed on a carrying surface 121 of the light source carrier 12. The lamp disk 13 is secured to the light source carrier 12 and located between the heat spreader 14 and the LED light source 11. In this illustration, the lamp disk 13 has the same structure as that of the traditional vehicle halogen headlamp.

Reference is next made to FIG. 2 for illustration of the connection between the light source module 1 and the automotive lighting device 2. The snapping structure 23 has an alignment guide 231 and a fastener 232. The alignment guide 231 is further provided with a hook 231a, whereas the fastener 232 has a pivot end 232a connected to the alignment guide 231. When the light source module 1 is assembled with the housing 22, the lamp disk 13 is aligned to the alignment guide 231 at first, followed by rotating the fastener 232 about the pivot end 232a as a pivot axis and then slightly forcing the fastener 232 into flexible deformation to engage the fastener 232 into the hook 231a so as to fasten the light source module 1. As shown in FIG. 2, the fastener 232′ outlined by a broken line is illustrated for an unlocked state. After the light source module 1 is positioned at the predetermined location, the fastener 232′ would be rotated with respect to the housing 22 to be closer to the alignment guide 231, resulting in a locked state, as shown by the fastener 232 outlined by a continuous line in FIG. 2. In the locked state, the fastener 232 is engaged in the hook 231a of the alignment guide 231, so that the lamp disk 13 is fastened between the alignment guide 231 and the fastener 232. By the aforementioned structure, the light source module 1 can be secured in the housing 22, and the light from the LED light source 11 can be reflected by a reflector in the interior of the housing 22 and emits outwardly through the lens 21.

The drawback arising from the conventional light source module 1 is that the lamp disk 13 is required for fastening the light source module 1 to the automotive lighting device 2. Unfavorably, the distance between the heat spreader 14 and the LED light source 11 is increased due to the disposition of the lamp disk 13 therebetween. Thereby, the light source module 1 having excessive length cannot be applied to all vehicle models. For instance, as some vehicles have limited spaces available for disposition of the headlamps in front of the engine compartment, the excessive length of the light source module 1 would cause short distance or even interference between the heat spreader 14 at the end of the light source module 1 and other components. Additionally, a longer heat dissipation path from the LED light source 11 to the heat spreader 14 through the light source carrier 12 would reduce heat dissipation efficiency and even result in failure of the LED light source 11 due to overheating. Furthermore, after purchasing the conventional light source module 1, the users usually assemble it with the automotive lighting device 2 to replace the traditional halogen light source by themselves. However, due to deficiency of professional skill and equipment, the users cannot confirm whether the light source module 1 is accurately installed to the automotive lighting device 2, or whether the light pattern meets the illumination requirements when the light source module 1 is applied in the vehicle model.

For the reasons stated above, an urgent need exists to provide a new light source module that has reduced length and size and addresses high thermal dissipation and modularity requirements.

### SUMMARY OF THE INVENTION

A primary objective of the present invention is to provide a light source module for a lighting device in which a heat dissipation body is formed with a fixing structure and thus can be directly attached to and secured to a housing of the lighting device so that the length of the light source module can be reduced to shorten the distance between an LED light source and the heat dissipation body. Additionally, as the contact area between the light source module and the lighting device can be increased by disposing the heat dissipation body in direct contact with a stationary base, all the heat dissipation, the stationary base and the housing can provide heat dissipation for spreading out heat generated by the LED, thereby enhancing the heat dissipation efficiency.

Another objective of the present invention is to provide a light source module for a lighting device in which the light source module can be directly associated with the lighting device by locking means with no fixing elements (such as the fastener and hook) provided on the lighting device. As a result, the quantity of components and cost of material can be reduced, and the light source module and the lighting device can be adapted to modular assembly. This modularity design is advantageous as the optimum states of the lighting device and the light source module can be ensured (for example, to check whether the light source is accurately assembled in the lighting device, whether the light pattern meets the regulations, and whether the fan works normally) on production line so that the lighting devices can be equipped in any vehicle models.

In accordance with the foregoing and other objectives, the present invention provides a light source module for a lighting device, the lighting device including a stationary base, the stationary base having a first fixing structure, and the light source module including a seat, at least one LED light source and a heat dissipation body. The seat extends along an axis and has a carrying surface. The heat dissipation body is connected with the seat and disposed at one end of the seat. Further, the heat dissipation body has a second fixing structure capable of being assembled to the first fixing structure. By the first and second fixing structures, the seat can be secured to the stationary base of the lighting device.

The lighting device may further include a housing that is connected to the stationary base and extends from the stationary base away from the axis to form a receiving space. The stationary base can be configured to have an annular shape and formed with a hollow region. When the seat extends through the hollow region and the first and second fixing structures are assembled with each other, the seat is located in the receiving space.

The stationary base has a first surface. On a vertical plane perpendicular to the axis, the heat dissipation body and the seat each have a cross-section. In a preferred embodiment, the cross-section of the heat dissipation body is larger than that of the seat. Accordingly, the heat dissipation body has a second surface exposed out of the seat. When the first and second fixing structures are assembled with each other, the first and second surfaces are in contact with each other.

In a preferred embodiment of the present invention, the first fixing structure of the lighting device includes a first alignment guide, whereas the second fixing structure of the light source module includes a second alignment guide. The first alignment guide and the second alignment guide have configurations substantially complementary to each other. Preferably, one of the first alignment guide and the second alignment guide is an alignment post, and the other one is an alignment slot.

The first fixing structure may further include at least one screw and at least one screw hole, whereas the second fixing structure can have at least one aperture corresponding to the screw hole. Accordingly, the screw can penetrate through the aperture and be screwed into the screw hole.

The heat dissipation body can be formed with a central through hole, and the LED light source preferably has a power cord extending outwardly through the central through hole.

The heat dissipation body may have a central receiving socket, and the lighting device can further include a fan disposed in the central receiving socket. Preferably, the heat dissipation body has a plurality of heat dissipation blocks spaced apart each other to define the central receiving socket, and airflow provided by the fan can pass through gaps between the heat dissipation blocks.

In a preferred embodiment, the housing is provided with a reflector on the inside thereof, and the lighting device has a lens disposed apart from the stationary base and connected to the housing. Accordingly, the light emitted from the LED light source can be reflected by the reflector and pass through the lens to form an illumination region in front of the lighting device.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of a conventional light source module and a conventional automotive lighting device;

FIG. 2 is a side cross-sectional view of a conventional light source module and a conventional automotive lighting device;

FIGS. 3 and 4 are perspective views of a light source module at different angular orientations in accordance with one example of the present invention;

FIG. 5 is an exploded perspective view of a light source module and a lighting device in accordance with one example of the present invention; and

FIG. 6 is a side cross-sectional view of a light source module and a lighting device in accordance with one example of the present invention.

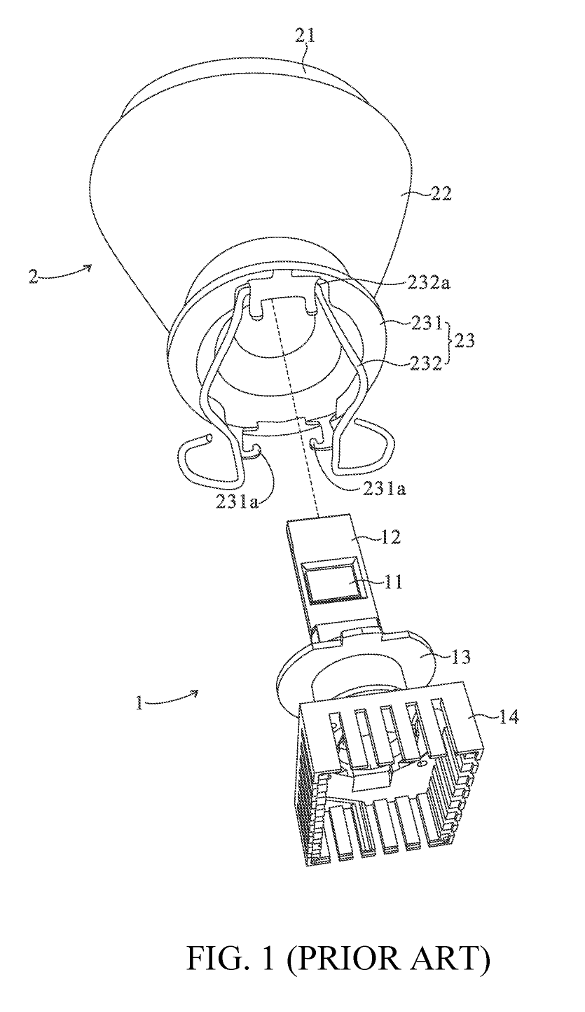

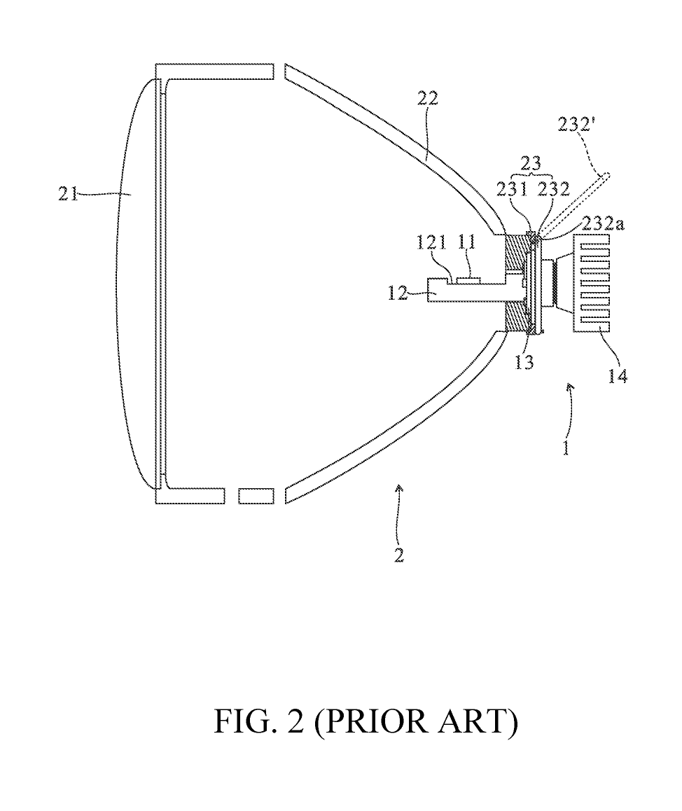

### DETAILED DESCRIPTION OF THE PREFERRED EMBODIMENT

Hereafter, examples will be provided for illustrating the embodiments of the present invention, but not for restricting the invention to any particular environment, application or manner described in the examples. Thereby, any description provided in the following examples is intended for clarifying the objective of the invention, but not for restricting the scope of the invention. It should be noted that duplicative or unnecessary elements may be omitted from the following examples and the accompanying figures. Additionally, the sizes of elements shown in the figures are depicted for improving clarity, and the practical scales are not limited thereto.

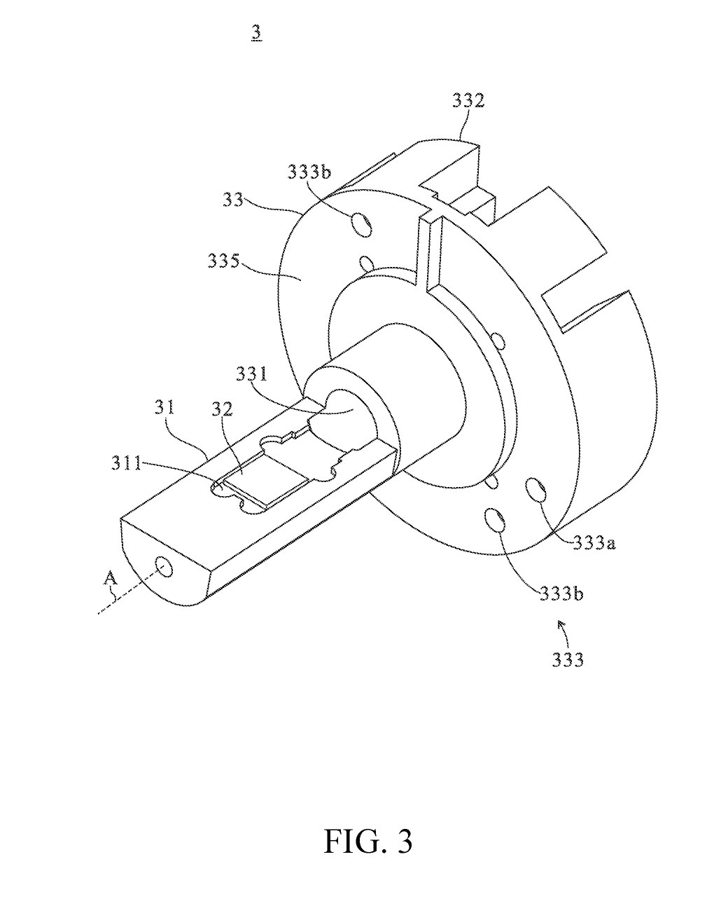

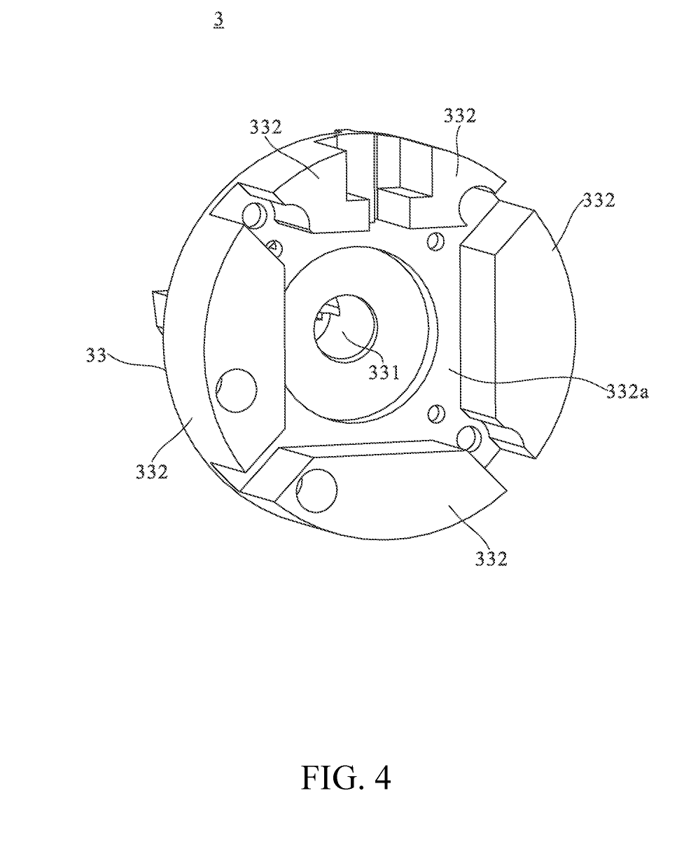

FIGS. 3 and 4 are perspective views of a light source module 3 at different angular orientations in accordance with the present invention. The light source module 3 of the present invention includes a seat 31, an LED light source 32 and a heat dissipation body 33. The seat 31 extends in an axis A and has a carrying surface 311. The LED light source 32 is disposed on the carrying surface 311. The heat dissipation body 33 is connected with the seat 31 and disposed at one end of the seat 31. More specifically, the heat dissipation body 33 is formed with a central through hole 331, and the LED light source 32 has a power cord extending outwardly through the central through hole 331 to be electrically connected to an external electronic component. Additionally, the heat dissipation body 33 further has a plurality of heat dissipation blocks 332 spaced apart each other in an annular arrangement to define a central receiving socket 332a.

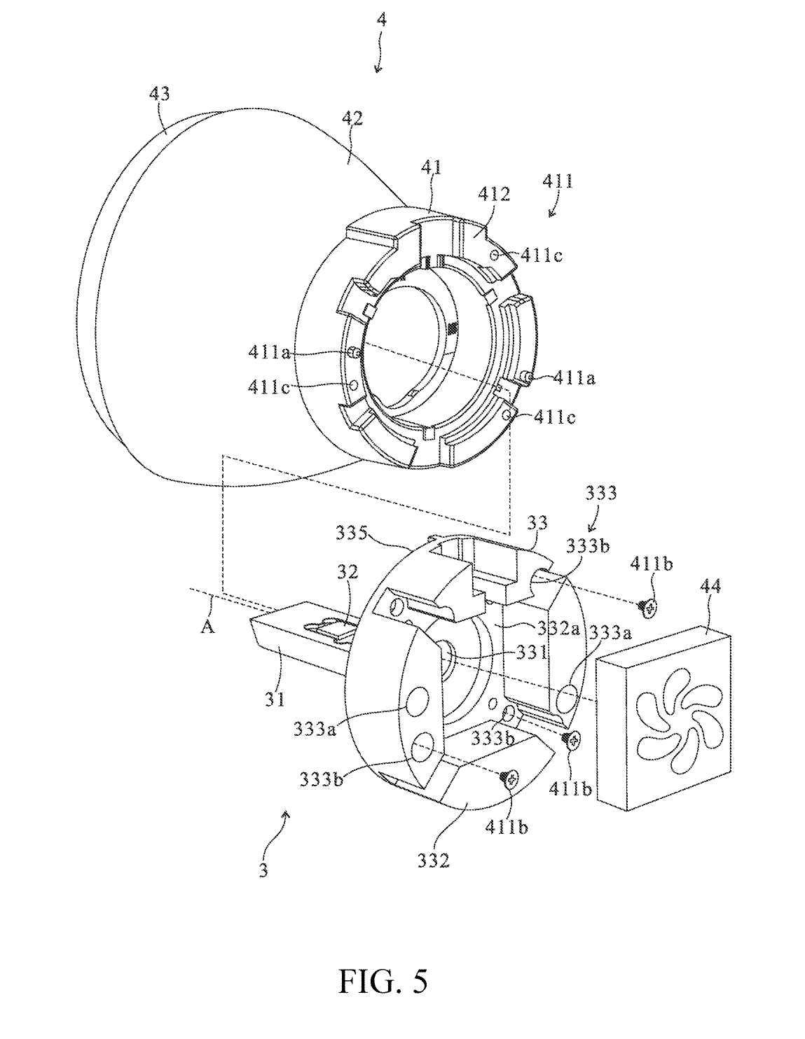

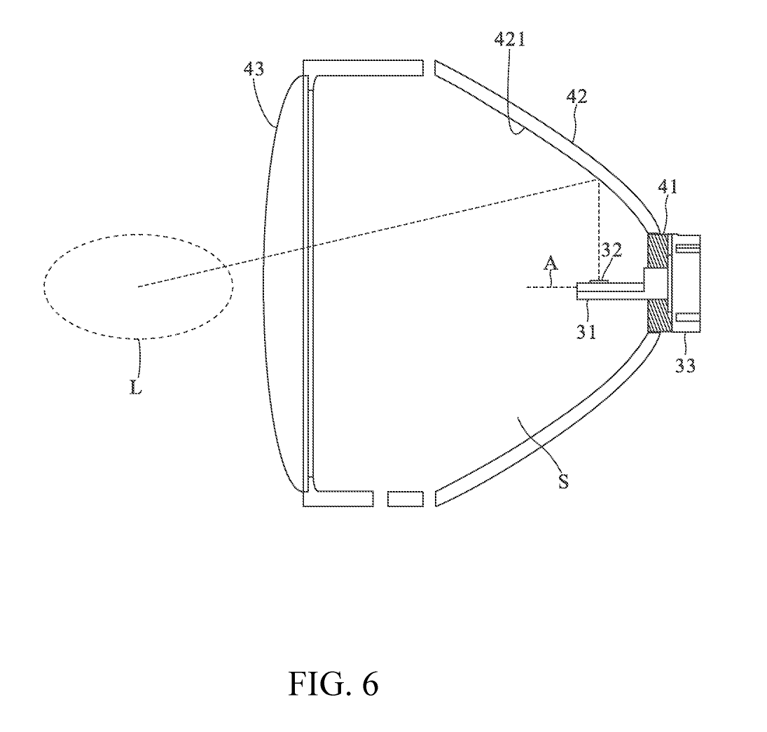

FIGS. 5 and 6 are schematic views of the light source module 3 separated from and assembled with a lighting device 4, respectively, in accordance with the present invention. The lighting device 4 includes a stationary base 41, a housing 42, a lens 43 and a fan 44. The inside of the housing 42 is provided with a reflector 421. In this example, the reflector 421 is a spherical reflector or a reflector having required curvature. The housing 42 is connected with the stationary base 41, and extends from the stationary base 41 away from the axis A to form a receiving space S. The stationary base 41 is configured into an annular shape and formed with a hollow region. The lens 43 is disposed apart from the stationary base 41 and connected to the housing 42. In other words, the lens 43 and the stationary base 41 are disposed at two opposite ends of the housing 42.

Detailed description is provided as follows in conjunction with FIGS. 3 and 5 for illustration of the assembly of the light source module 3 and the lighting device 4. The stationary base 41 has a first surface 412 and a first fixing structure 411. The first fixing structure 411 can include a plurality of first alignment guides 411a, a plurality of screw holes 411c, and a plurality of screws 411b. In this embodiment, each of the first alignment guides 411a is illustrated as an alignment post. The cross-section (perpendicular to the axis A) of the heat dissipation body 33 is larger than that (perpendicular to the axis A) of the seat 31. As a result, the heat dissipation body 33 has a second surface 335 exposed out of the seat 31. Further, the heat dissipation body 33 is formed with a second fixing structure 333 that includes a plurality of apertures 333b and a plurality of second alignment guides 333a. In this embodiment, each of the second alignment guides 333a is illustrated as an alignment slot.

The seat 31 extends through the hollow region of the stationary base 41 and is located within the receiving space S (as shown in FIG. 6). Subsequently, each first alignment guide 411a and each second alignment guide 333a are aligned with each other to guide the first surface 412 and the second surface 335 into contact with each other at a predetermined location. Further, each aperture 333b is also aligned with each screw hole 411c. Accordingly, each screw 411b can extend through each aperture 333b and be screwed into each screw hole 411c. As a result, the heat dissipation body 33 is fastened to the stationary base 41 so as to install the light source module 3 to the lighting device 4.

By the structural matching between the first fixing structure 411 and the second fixing structure 333, the heat dissipation body 33 and the stationary base 41 can be aligned and secured with each other. After assembly, the LED light source 32 is situated at a predetermined location within the receiving space S. The light emitted from the LED light source 32 can be reflected by the reflector 421 and pass through the lens 43 to form an illumination region L in front of the lighting device 4. As the position of the LED light source 32 is properly controlled, the light pattern and the location of the illumination region L can meet the illumination regulations. Additionally, a large amount of heat generated by the LED light source 32 during light emission can be dissipated to the heat dissipation body 33 through the seat 31. Meanwhile, the heat at the housing 42 under long-term illumination of the LED light source 32 also can be thermally conducted to the heat dissipation body 33 through the stationary base 41. The fan 44 is disposed in the central receiving socket 332a and does not project out of the light source module 3. As a result, the fan 44 would not cause the increase in the total length of the assembly, and can provide airflow through the central through holes 331 and the gaps between the heat dissipation blocks 332 to assist spreading out the heat transferred to the heat dissipation body 33.

In other examples, the surfaces of the seat 31 and the heat dissipation body 33 may be further spray coated with nano-scale heat dissipation materials. For example, binders or nano-scale ceramic powders (such as alumina, zinc oxide, titanium oxide, boron nitride or other ceramic powders) may be added in an organic solvent for spreading out the heat generated from the LED light source 32 by far IR radiation of a wavelength range from 6 μm to 1 mm, thereby enhancing heat dissipation efficiency. Alternatively, if no fan 44 is provided, far IR radiation may be directly applied for the heat dissipation of the light source module 3.

In another example, a heat pipe (not shown in figures) may be embedded in the central through hole 331 of the seat 31. Specifically, one end of the heat pipe may be embedded in the seat 31 to be located below the light source 32 and substantially contacts the bottom of the light source 32, whereas the other end of the heat pipe extends along the central through hole 331 to the heat dissipation body 33 and substantially contacts the heat dissipation body 33. By the rapid heat exchange in the interior of the heat pipe, the heat generated by the LED light source 32 can be rapidly transferred to the heat dissipation body 33 at the rear of the LED light source 32 so as to ensure the performance of the LED light source 32.

It should be noted that the configurations, quantities and locations of the LED light source 32, the screw holes 411c, the apertures 333b, the first alignment guides 411a and the second alignment guides 333a can be modified according to requirement. In other examples, the first alignment guides 411a and the second alignment guides 333a may be designed into any configurations substantially complementary to each other so as to provide alignment function in an annular direction. For instance, the first alignment guides 411a and the second alignment guides 333a may be selected from the group consisting of alignment posts and alignment slots.

Additionally, in this example, the seat 31 and the heat dissipation body 33 may be integrated into one piece, and preferably are made of materials having higher thermal conductivity. Accordingly, the heat generated by the LED light source 32 not only can be dissipated through the heat dissipation body 33, but also may be further transferred to the stationary base 41 and the housing 42 through the heat dissipation body 33 so as to enhance overall heat dissipation efficiency for the light source module 3. For instance, the seat 31 and the heat dissipation body 33 may be made of aluminum, copper, lead, tin, magnesium, zinc, steel, titanium, polymer, ceramic or a combination thereof. More preferably, the heat dissipation body 33 further includes at least one heat pipe (not shown in the figures) and/or a plurality of fins (not shown in the figures). Alternatively, the seat 31 may be coated with a coating layer with higher thermal conductivity to enhance the heat dissipation efficiency for the light source module 3. For instance, the aforementioned coating layer may be made of tin oxide, aluminum oxide, silicon carbide, boron oxide, graphene or carbon nanotube.

In conclusion, compared to conventional light source modules, the lamp disk can be omitted in accordance with the present invention so as to reduce the total length of the light source module. As a result, the light source module of the present invention can overcome the space limitation of different vehicle models, and the quantity of components and cost of material can be reduced. In particular, by the heat dissipation body being directly secured to the stationary base of the lighting device, the contact surface between the heat dissipation body and the stationary base is increased so as to transfer the heat generated by the LED light source to the heat dissipation body and further to the stationary base and the housing, resulting in enhancement of the heat dissipation efficiency. In other words, all the heat dissipation body, the stationary base and the housing can offer heat dissipation function for spreading out heat from the LED light source, thereby improving thermal performance for the LED light source. Furthermore, in accordance with the present invention, the modularity characteristic of the light source module and the lighting device is advantageous as the light source module and the lighting device can be installed and tested by the professional staff of the automobile industry rather than the users.

Although the present invention has been explained in relation to its preferred embodiment, it is to be understood that many other possible modifications and variations can be made without departing from the spirit and scope of the invention as hereinafter claimed.

What is claimed is:

1. A light source module for a lighting device, the lighting device including a stationary base, the stationary base having a first fixing structure, and the light source module comprising:
a seat that extends along an axis and has a carrying surface;
at least one LED light source that is disposed on the carrying surface; and
a heat dissipation body that is connected with the seat and disposed at one end of the seat, wherein the heat dissipation body has a second fixing structure capable of being assembled with the first fixing structure to secure the light source module on the stationary base of the lighting device.

2. The light source module of claim 1, wherein (i) the lighting device further includes a housing that is connected to the stationary base and extends from the stationary base away from the axis to form a receiving space, (ii) the stationary base is configured to have an annular shape and formed with a hollow region, and (iii) when the seat extends through the hollow region and the first and second fixing structures are assembled with each other, the seat is located in the receiving space.

3. The light source module of claim 2, wherein (i) the stationary base has a first surface, and the heat dissipation body and the seat each have a cross section in a vertical plane perpendicular to the axis, (ii) the cross section of the heat dissipation body is larger than that of the seat so that the heat dissipation body has an exposed second surface out of the seat, and (iii) when the first fixing structure and the second fixing structure are assembled with each other, the first surface and the second surface are in contact with each other.

4. The light source module of claim 3, wherein (i) the first fixing structure includes a first alignment guide, (ii) the second fixing structure includes a second alignment guide, and (iii) the first alignment guide and the second alignment guide have configurations substantially complementary to each other.

5. The light source module of claim 4, wherein each of the first alignment guide and the second alignment guide is selected from the group consisting of an alignment post and an alignment slot.

6. The light source module of claim 3, wherein (i) the first fixing structure further includes at least one screw and at least one screw hole, (ii) the second fixing structure has at least one aperture corresponding to the screw hole, and (iii) the screw is capable of penetrating through the aperture and being screwed into the screw hole.

7. The light source module of claim 3, wherein the heat dissipation body is formed with a central through hole, and the LED light source has a power cord extending outwardly through the central through hole.

8. The light source module of claim 7, wherein the heat dissipation body has a central receiving socket, and the lighting device further includes a fan to be disposed in the central receiving socket.

9. The light source module of claim 8, wherein the heat dissipation body has a plurality of heat dissipation blocks spaced apart each other to define the central receiving socket, and the fan is capable of providing airflow through the central through holes and gaps between the heat dissipation blocks.

10. The light source module of claim 2, wherein (i) the housing is provided with a reflector on the inside thereof, (ii) the lighting device further includes a lens disposed apart from the stationary base and connected to the housing, and (iii) when light emitted from the LED light source is reflected by the reflector and passes through the lens, an illumination region is generated in front of the lighting device.
